(19) United States
(12) Patent Application Publication
(10) Pub. No.: US 2010/0283310 A1
(43) Pub. Date: Nov. 11, 2010

(54) Head Restraint Device

(76) Inventor: Thomas Howell Blackwood, San Diego, CA (US)

Correspondence Address: Trevor Q. Coddington, Esq.;San Diego IP Law Group LLP, 12526 High Bluff Drive, Suite 300, San Diego, CA, 92130, US

(21) Appl. No.: 12/436,686

(22) Filed: May 6, 2009

(51) Int. Cl. B60R 21/02; B23P 11/00

(52) U.S. Cl. 297/464; 29/428

(57) ABSTRACT

The present invention provides an improved head restraint device for securing a person's head to a headrest such as those found on vehicle passenger seats. The head restraint immobilizes the person's head, neck, and spine in all degrees of freedom, e.g., lateral, longitudinal or frontal, and rotational, relative to the headrest. Yet, when a threshold amount of external force is applied to the person's head, particularly in a frontal or normal direction relative to the passenger seat, the person's head will separate itself from the headrest to prevent injury to the person.

### BACKGROUND OF THE INVENTION

1. Field of Invention

This invention relates to head support and restraint devices and more specifically, to an improved head restraint device for securing a person's head to a vehicle headrest, while permitting the head to free itself from the headrest upon relatively large forces, e.g., turbulence, being applied to the person's head and/or neck, thereby preventing injury to the user.

2. Description of Related Art

Being unconscious or sleeping while sitting upright in a vehicle seat can be awkward and very uncomfortable if the head falls forward or to the side. After a relatively short time with the head in this unnatural position, the person may wake and the neck and upper-back may become strained, soar, and/or ache. Moreover, if sudden vehicle movement or turbulence occurs while the person is seated, the movement of the person's upper torso, spine, and unsecured head could be quite dramatic and possibly lead to injury.

U.S. Pat. No. 5,154,477 to Lacy, the disclosure of which is incorporated by reference herein in its entirety, proposes a portable head support, i.e., U-shaped formed pillow, that partially wraps around the user's head and is secured to a slipcover placed over a seat and/or headrest. This type of support device provides a relatively small degree of lateral support to a person's head while sitting in an upright, non-leaning position. However, this device does not prevent the person's head from falling forward, i.e., out of the support pillow, or rotating relative to the support pillow.

### SUMMARY OF THE INVENTION

The present invention overcomes these and other deficiencies of the prior art by providing a head restraint device that secures a person's head to a vehicle seat or headrest, and prevents the person's head from moving relative to the headrest in all degrees of freedom, particularly during sleep or unconscious. Yet, if sudden vehicle movement or turbulence is experienced, i.e., a threshold amount of external force is applied to the person's head, the head restraint will separate itself from the seat or headrest.

In an embodiment of the invention, a head restraint device comprises: a headrest or seat attachment band, a head restraint disposed on the attachment band, a headband, and a fastener for detachably coupling the head band to the head restraint. The headrest or seat attachment band is configured to be secured to a headrest or seat. The head restraint prevents relative movement of a person's head when the headband is coupled to the head restraint. The head restraint can be U-shaped. The fastener may comprise Velcro. The headband decouples from the head restraint upon application of a threshold amount of force.

In another embodiment of the invention, a head restraint device comprises: a U-shaped head restraint, means for securing the head restraint to an object, a headband, means for securing the headband to a person's head, and means for detachably coupling the headband to the head restraint. The object comprises a headrest. The device immobilizes the person's head relative to the headrest. The means for detachably coupling the headband to the head restraint may comprise Velcro or magnets, and decouples upon application of a threshold amount of force.

In yet another embodiment of the invention, a method of immobilizing a person's head relative to an object comprises the steps of: securing a headband to a person's head, securing a head restraint band to an object, the head restraint band comprising a head restraint, and coupling the headband to the head restraint, wherein the headband and the head restraint may be later decoupled from one another upon application of a threshold amount of force. The step of securing a headband comprises adjusting the length of the headband. The step of securing a head restraint band to an object comprises adjusting the length of the head restraint band. The step of coupling the headband to the head restraint comprises fastening a Velcro fastener. The object may comprise a headrest.

By allowing the headband to free itself from the head restraint, the possibility of straining the head, spine, or neck upon turbulence or other external disruptive forces is minimized. Thus, the present invention is safer than conventional head restraint devices. Another advantage of the invention is that lightweight equipment can be attached to the headband or head restraint band within easy reach of the person. Moreover, only the headband needs washing for hygienic maintenance.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a head restraint device according to an embodiment of the invention;

FIG. 2 illustrates the head restraint device of FIG. 1 in use according to an embodiment of the invention;

FIG. 3 illustrates an alternative head restraint device according to another embodiment of the invention; and

FIG. 4 illustrates a head restraint device built directly into a headrest according to an embodiment of the invention.

### DETAILED DESCRIPTION OF EMBODIMENTS

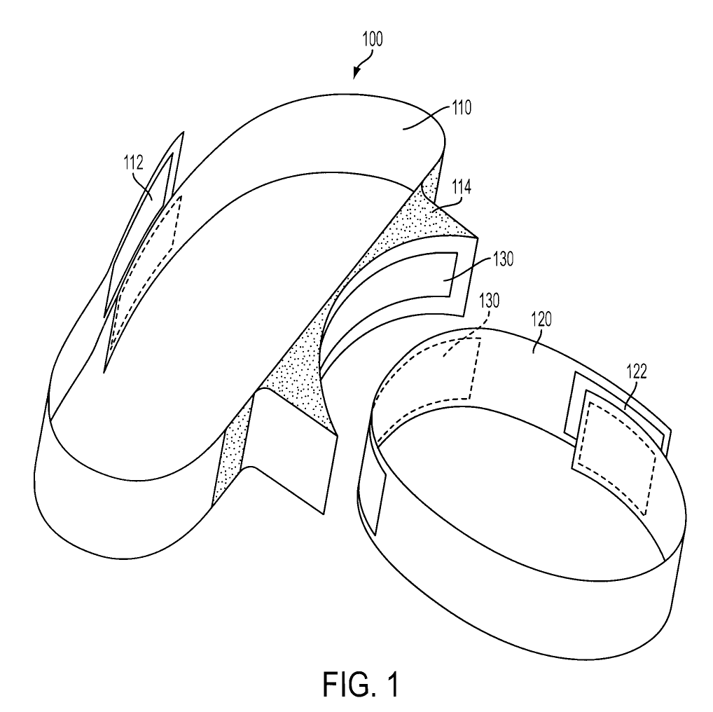

Further features and advantages of the invention, as well as the structure and operation of various embodiments of the invention, are described in detail below with reference to the accompanying FIGS. 1-4, wherein like reference numerals refer to like elements. Although the head restraint device of the present invention is described in the context of a vehicle passenger seat headrest, one of ordinary skill in the art readily appreciates that the present invention can be implemented in any type of system where it is desired to immobilize a person's head and/or neck relative to a stationary object such as, but not limited to an ambulatory backboard, a stretcher, a gurney, a table, a bed, or a wheelchair.

The present invention provides an improved head restraint device for securing a person's head to a headrest such as those found on vehicle passenger seats. The head restraint immobilizes the person's head, neck, and spine in all degrees of freedom, e.g., lateral, longitudinal or frontal, and rotational, relative to the headrest. Yet, when a threshold amount of external force is applied to the person's head, particularly in a frontal or normal direction relative to the passenger seat, the person's head will separate itself from the headrest to prevent injury to the person.

FIG. 1 illustrates a head restraint device 100 according to an embodiment of the invention. Particularly, the head restraint device 100 comprises a seat attachment band 110 and a headband 120. The seat attachment band 110 comprises a fastener 112 and a head restraint 114. The headband 120 comprises a fastener 122. The seat attachment band 110 and the headband 120 are detachably coupled to one another via fastener 130.

The head restraint 114 is preferably U-shaped and constructed from a moldable foam or material that is rigid enough to keep its shape, but soft enough to prevent any discomfort to the person when receiving the head of that person. The head restraint 114 by itself provides a degree of lateral support, i.e., it prevents the person's head from moving shoulder to shoulder. To improve comfort, the head restraint 114 may comprise a soft or smooth exterior material such as, but not limited to leather, silk, cotton, satin, acrylic, velvet, or a combination thereof.

In operation, the seat attachment band 110 is secured to a headrest by placing it around a headrest and binding the fastener 112. The headband 120 is placed around a person's head and secured to the head by binding the fastener 122. The headband 120 is then coupled to the head restraint 114 of the seat attachment band 110 by binding fastener 130. With the head band 120 secured to the head restraint 114, the person's head and neck is immobilized relative to the headrest, thereby preventing the person's head from falling forward, moving side to side, or rotating awkwardly. In other words, the head restraint device 110 prevents the person's head from substantially moving in any degree of freedom, e.g., longitudinal, lateral, and rotational, relative to the headrest. Yet, because the headband 120 may be detachably coupled to and from the head restraint 114, the headband 120 can release itself from the head restraint 114 when a predetermined threshold amount of external force, e.g., turbulence, is applied to the person's head. For example, the fastener 130 will release, e.g., unbind itself, upon adverse and/or aggravated seat movement, thereby preventing injury to the user's neck or back under such circumstances.

In an embodiment of the invention, fasteners 112, 122, and 130 comprise Velcro strips, the implementation of which are apparent to one of ordinary skill in the art. Velcro is a brand name of fabric hook-and-loop fasteners and is used herein to represent any material that comprises two layers: a “hook” side, which is a piece of fabric covered with tiny hooks, and a “loop” side, which is covered with even smaller and “hairier” loops. When the two sides are pressed together, the hooks catch in the loops and hold the pieces together. However, the two sides can be later separated from one another upon a threshold amount of pulling force being applied to the two sides, i.e., the two sides can be pulled apart from one another usually by hand. One of ordinary skill in the art appreciates that the implementation of Velcro fasteners is exemplary only and other types of fasteners can be used instead, the identification and implementation of which is apparent to one of ordinary skill in the art. For example, fasteners 112, 122, and 130 may comprise loops, buckles, clips, hooks, snaps, buttons, magnets, cam buckles, side release buckles, cord locks, or a combination thereof.

Fasteners 112 and 122 permit the respective bands 110 and 120 to be closed and if necessary adjusted in length, e.g., loosened or tightened, to adjust to different size headrests and heads. For example, fastener 112 allows the seat attachment band 110 to be secured to any size headrest or passenger seat. Similarly, the fastener 122 may be adjusted to accommodate varying sized heads of the users of the head restraint device 110.

In an exemplary embodiment of the invention, the attachment bands 110 and 120 comprise a relatively inelastic, but somewhat flexible material such as nylon—where immobility of the person's head depends on the degree of inelasticity balanced against comfort, which depends on the degree of flexibility. However, other types of material can be implemented such as, but not limited to a polymer, leather, cotton, wool, silk, canvas, rubber, spandex, or a combination thereof so long as it prevents movement when tightened around the respective seat and person's head. In an exemplary embodiment of the invention, the seat attachment band 110 is constructed from a nylon strap five feet in length and having a width of one inch. The head band 120 is constructed from a nylon strap three feet in length and having a width of one and one half inches. In an alternative embodiment of the invention, the bands 110 and 120 can be constructed of an elastic material that can be stretched over the respective seat or head of a user. The elasticity of that material when stretched naturally provides the tightening necessary to keep the bands 110 and 120 secured and resistant to movement.

It is important to again note that the fastener 130 should release upon a significant amount of adverse and/or aggravated seat movement, thereby preventing injury inflicted to the user's neck, spine, or back under such circumstances. The threshold amount of force needed to release or unbind the fastener 130 depends on the type of fastener used. For example, if Velcro strips are implemented as the fastener 130, the threshold amount of force needed to pull apart the fastener will depend on the surface area of the Velcro. Thus, the threshold amount of force needed to separate the headband 120 from the head restraint 114 can be predetermined by varying the fastening strength of the fastener 130, e.g., varying the amount of Velcro used. In an alternative embodiment of the invention, the fastener 130 comprises magnets where the threshold release force will depend on the strength of the magnets.

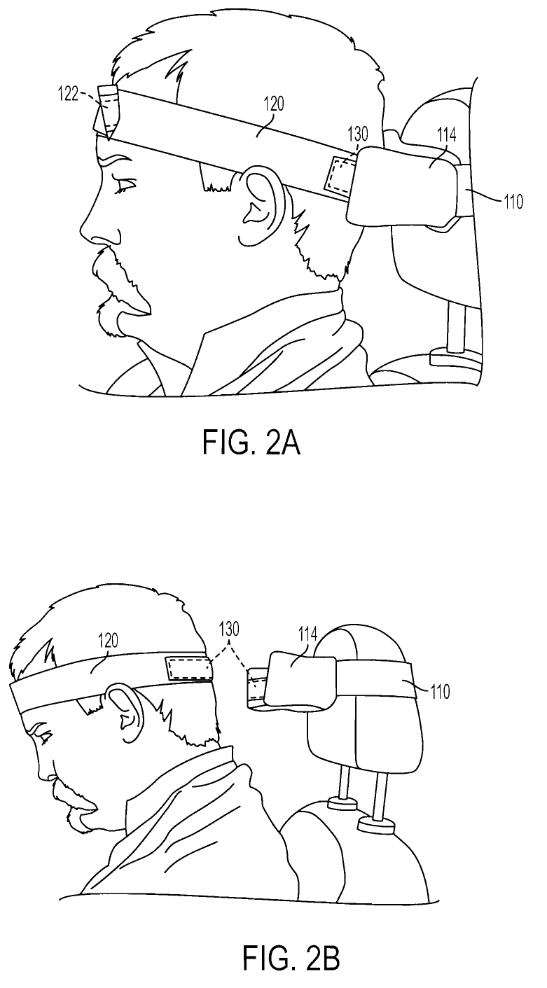

FIG. 2 illustrates the head restraint device 100 in use according to an embodiment of the invention. Referring to FIG. 2A, the seat attachment band 110 has been secured to a seat of an automobile and the headband 120 has been secured to the head of a person. As shown, the headband 120 is coupled to the head restraint 114 via the fastener 130. Referring to FIG. 2B, the head band 120 has been decoupled from the head restraint 114 by unbinding the fastener 130.

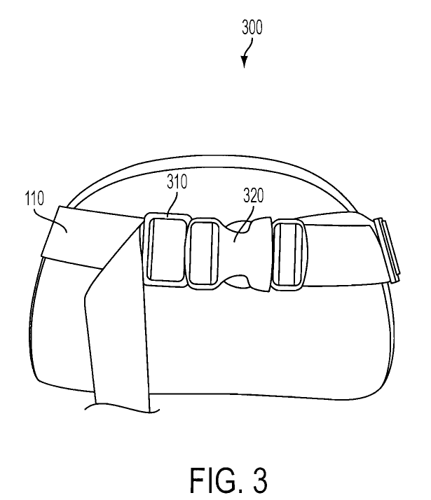

FIG. 3 illustrates a head restraint device 300 according to another embodiment of the invention. Rather than using a velcro fastener, the seat attachment band 110 of this device comprises a loop 310 and a quick release buckle 320. The loop 310 allows adjustment of the overall length of the attachment band 110. The quick release buckle 320 permits the attachment band 110 to be secured and unsecured to a seat or suitable headrest. This type of fastener can also be implemented in the headband 120.

Straps 110 and 120 may include optional fasteners and/or attachments for securing equipment to the device 110. For example, head strap 120 may include a fastener (not shown) for attaching headphones, a reading light, earplugs, a bag, an eye cover, or any other relatively lightweight device desired by the person. The device 100 may optionally comprise a head cover (not shown) for keeping the head warm.

In an alternative embodiment of the invention, a chin strut (not shown) is included within the device 110 for placement under the chin of the person, which runs from the user's chin to chest, as an additional measure to prevent the person's head from moving forward. The chin strut is preferably collapsible, e.g., a telescoping rod, in the event of turbulence or large forces being placed on the person such that it may collapse in a safe manner as to prevent injury to the person.

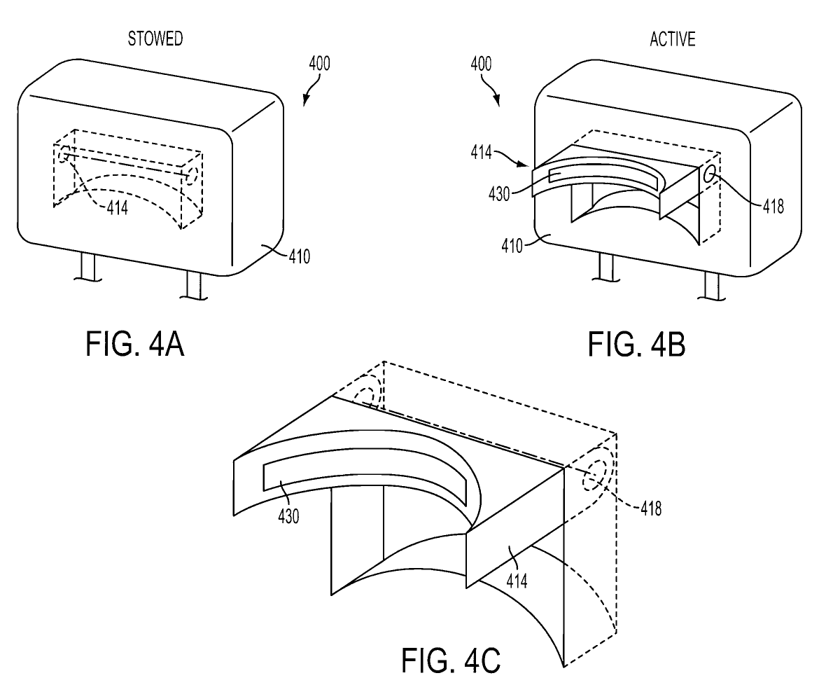

FIG. 4 illustrates a head restraint device 400 built directly into a headrest according to an embodiment of the invention. Particularly, the head restraint device 400 comprises a head restraint 414 affixed to a headrest 410. The head restraint 414 is similar to the head restraint 114 as discussed above, except that it is affixed to the headrest 410 through a support rod 418 rather than a seat attachment band. The support rod 418 permits the head restraint 414 to be rotated into a stowed position (as shown in FIG. 4A) or an active position (as shown in FIG. 4B and FIG. 4C, the latter being a close-up). For example, in the stowed position, the head restraint 414 fits snugly within its appropriately sized compartment in the headrest 410 and the headrest 410 functions as if the head restraint 414 was not there. However, in the active position, the head restraint 414 has been rotated 90 degrees away from the headrest 410 so that it can receive the headband 120 through fastener 430, which can be the same fastener as fastener 130. Head restraint 414 may optionally include an internal vertical track connected to the hinge 418 that accommodates it moving up and down within headrest 410 to accommodate different sized people.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A head restraint device comprising:
an attachment band,
a head restraint disposed on said attachment band,
a headband, and
a fastener for detachably coupling said head band to said head restraint.

2. The device of claim 1, wherein said attachment band is configured to be secured to a headrest or seat.

3. The device of claim 1, wherein said head restraint prevents relative movement of a person's head when said headband is coupled to said head restraint.

4. The device of claim 1, wherein said head restraint is U-shaped.

5. The device of claim 1, wherein said fastener comprises Velcro.

6. The device of claim 3, wherein the headband decouples from the head restraint upon application of a threshold amount of force.

7. A head restraint device comprising:
a U-shaped head restraint,
means for securing said head restraint to an object,
a headband,
means for securing said headband to a person's head, and
means for detachably coupling said headband to said head restraint.

8. The device of claim 7, wherein said object comprises a headrest.

9. The device of claim 8, wherein said device immobilizes said person's head relative to said headrest.

10. The device of claim 7, wherein said means for detachably coupling said headband to said head restraint comprises Velcro.

11. The device of claim 7, wherein said means for detachably coupling said headband to said head restraint comprises magnets.

12. The device of claim 7, wherein said means for detachably coupling said headband to said head restraint decouples upon application of a threshold amount of force.

13. The device of claim 7, wherein said means for securing said head restraint to an object comprises a rod upon which said head restraint can be rotated around said rod.

14. A method of immobilizing a person's head relative to an object, the method comprising the steps of:
securing a headband to a person's head,
securing a head restraint band to an object, said head restraint band comprising a head restraint, and
coupling said headband to said head restraint, wherein said headband and said head restraint may be later decoupled from one another upon application of a threshold amount of force.

15. The method of claim 14, wherein the step of securing a headband comprises the step of adjusting the length of the headband.

16. The method of claim 14, wherein the step of securing a head restraint band to an object comprises the step of adjusting the length of the head restraint band.

17. The method of claim 14, wherein the step of coupling said headband to said head restraint comprises the step of fastening a Velcro fastener.

18. The method of claim 14, wherein said object comprises a headrest.
